(19) United States
(12) Patent Application Publication
(10) Pub. No.: US 2024/0220768 A1
(43) Pub. Date: Jul. 4, 2024

(54) OPTIMIZING OFF-CHIP MEMORY ACCESSES ON A NEURAL NETWORK HARDWARE ACCELERATOR

(71) Applicant: Google LLC, Mountain View, CA (US)

(72) Inventors: Dan Zhang, San Bruno, CA (US); Safeen Huda, San Jose, CA (US); Azalia Mirhoseini, Mountain View, CA (US); Anna Darling Goldie, San Francisco, CA (US); Ebrahim Songhori, San Jose, CA (US)

(21) Appl. No.: 18/285,977

(22) PCT Filed: Apr. 6, 2022
(86) PCT No.: PCT/US2022/023739

§ 371 Date: Oct. 6, 2023

Related U.S. Application Data
(60) Provisional application No. 63/191,300, filed on May 20, 2021.
(60) Provisional application No. 63/171,526, filed on Apr. 6, 2021.

(51) Int. Cl. G06N 3/04

(52) U.S. Cl. CPC G06N 3/04

(57) ABSTRACT

Methods, systems, and apparatus, including computer programs encoded on computer storage media, for determining a hardware datapath for a hardware accelerator computer chip.

### BACKGROUND

This specification relates to determining how to store input activations, output activations and weights of the layers of a neural network deployed on a hardware accelerator computer chip.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that determines an architecture for a hardware accelerator computer chip that is used to perform inference for a target set of one or more neural networks, i.e., a special purpose computer chip that accelerates the processing of inputs using the target set of neural networks to generate predicted outputs.

This specification also describes a system implemented as computer programs on one or more computers in one or more locations that determines how to store input activation tensors, output activation tensors and weight tensors of the layers of a neural network deployed on a hardware accelerator computer chip.

That is, the system determines a fusion strategy that specifies, for each of these tensors, whether the tensor is to be stored in off-chip memory or in on-chip memory of the accelerator chip while performing inference while the neural network is deployed on the hardware accelerator.

Particular embodiments of the subject matter described in this specification can be implemented so as to realize one or more of the following advantages.

This specification describes techniques for effectively determining an architecture for a hardware accelerator that can optimize the execution of a target set of neural network workloads, i.e., a target set of one or more neural networks. In particular, the techniques described in this specification identify architectures that optimize a (user-specified) objective function that measures the performance of the accelerator when performing inference on the target set of one or more neural networks.

More specifically, this specification describes a full-stack accelerator search technique that performs joint optimization of the hardware datapath of the accelerator and the fusion strategy that defines where tensors associated with layers of the neural network are stored, i.e., in on-chip memory or in off-chip, when inference is performed using the accelerator.

This joint optimization allows the system to discover accelerator architectures (also referred to as “accelerator designs”) that outperform existing baseline accelerators or accelerators discovered using other search techniques that do not make use of this joint optimization. As a particular example, accelerator designs discovered using the described techniques achieve an average of 3.65× better Perf/TDP on state-of-the-art vision models compared to baseline accelerators, e.g., TPU-v3.

In addition to or instead of jointly optimizing the datapath and the fusion strategy, the described techniques can also jointly optimize the configuration of the processing elements in the datapath and the configuration of the memory in the datapath. Performing this optimization results in a search space that represents a wider range of possible accelerator architectures and allows the system to more narrowly tailor the architecture of the accelerator to the target set of one or more neural networks, resulting in improved performance relative to existing baseline accelerators or accelerators discovered using other search techniques that do not make use of this wider search space.

This specification also describes techniques for determining a fusion strategy for an accelerator chip, e.g., an already-fabricated chip or a candidate accelerator chip that is being considered during the above-described search process.

Machine learning models, e.g., neural networks, are generally executed on accelerators as a series of kernels, or operations, where each operation reads its inputs from device memory, e.g., dynamic random-access memory (DRAM) of the host device for the accelerator chip, transfers these inputs to on-chip memory, performs the computation required by the operation, and writes the output of the computation back to DRAM. This results in unnecessary DRAM reads and writes for intermediate values, i.e., a large number of reads from and writes to the device memory for intermediate values that are provided as input to and generated as output of the hidden layers of the neural network. While these DRAM reads and writes can sometimes be performed in parallel with computation, they still may cause slowdowns with insufficient bandwidth.

The described techniques mitigate this issue by implementing a fusion strategy, which results in the merging of multiple operations into one large operation to avoid DRAM accesses of intermediate results, resulting in greater operational intensity and improved performance. In other words, the fusion strategy merges multiple operations into one large operation by storing tensors associated with the operations in on-chip memory rather than in device memory, thereby only requiring accessing off-chip memory before the first of the multiple operations and after the last of the multiple operations.

While most prior work has focused on fusion for training, where intermediate results must be preserved for the backwards pass, the described techniques focus on inference, which does not require a backwards pass, meaning that intermediate results may be immediately discarded after use. That is, the described techniques leverage the fact that intermediate results can be immediately discarded to generate a fusion strategy that is optimized for inference (when the weights of the neural network are fixed) rather than for training (when the weights of the neural network are being adjusted).

Moreover, the described techniques automatically optimize DRAM accesses through strategic utilization of on-chip memory, e.g., a static random-access memory (SRAM)-based Global Memory, which offers significantly higher access bandwidth. The described techniques extend traditional operation fusion to allow multiple layers to be fused together given sufficient on-chip memory capacity and ensure that some combination of input activations, output activations, and weights of memory-bound layers are resident in on-chip memory, leading to performance improvements.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example accelerator architecture search system.

FIG. 2 shows an example datapath for a hardware accelerator computer chip.

FIG. 3 shows an example of the operation of a candidate generation system at a given search iteration.

FIG. 4 is a flow diagram of an example process for determining an architecture for a hardware accelerator computer chip.

FIG. 5 shows an example fusion system.

FIG. 6 is a flow diagram of an example process for determining a fusion strategy.

Like reference numbers and designations in the various drawings indicate like elements.

### DETAILED DESCRIPTION

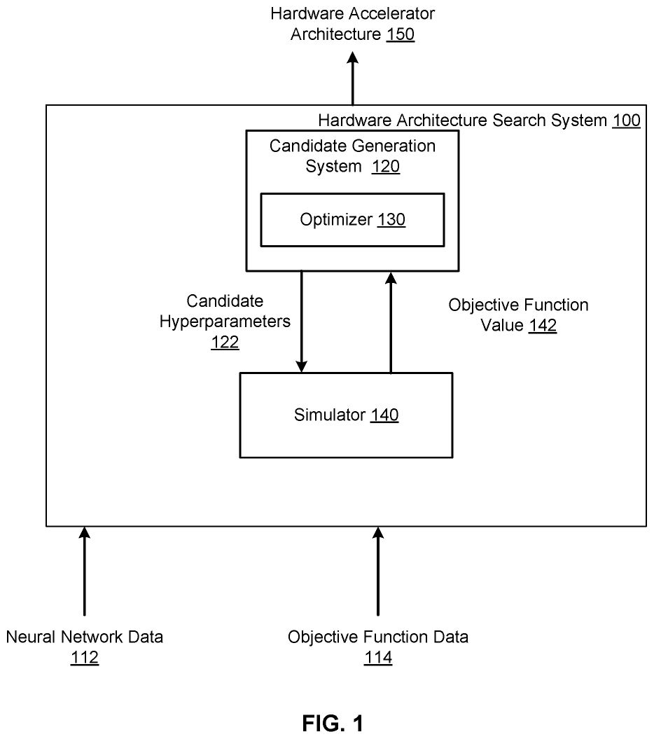

FIG. 1 shows an example accelerator architecture search system 100. The accelerator architecture search system 100 is an example of a system implemented as computer programs on one or more computers in one or more locations, in which the systems, components, and techniques described below can be implemented.

The system 100 determines an architecture for a hardware accelerator computer chip that is used to perform inference for a target set of one or more neural networks, i.e., a special purpose computer chip that accelerates the processing of inputs using the target set of neural networks to generate predicted outputs.

In particular, the system 100 obtains neural network data 112 specifying a target set of one or more neural networks.

Each neural network in the target set is configured to perform a respective machine learning task.

When there are multiple neural networks in the set, the tasks can be the same for all of the neural network or different for different neural networks.

The respective machine learning task performed by a given neural network can be any appropriate machine learning task.

For example, the machine learning task can be a computer vision task (also referred to as an “image processing task”). In other words, the neural network is a convolutional neural network or different type of neural network (e.g., a Transformer based neural network) that is configured to receive an input image and to process the input image to generate a network output for the input image, i.e., to perform some kind of image processing task. In this specification, processing an input image refers to processing the intensity values of the pixels of the image using a neural network.

For example, the task may be image classification and the output generated by the neural network for a given image may be scores for each of a set of object categories, with each score representing an estimated likelihood that the image contains an image of an object belonging to the category.

As another example, the task can be image embedding generation and the output generated by the neural network can be a numeric embedding of the input image.

As yet another example, the task can be object detection and the output generated by the neural network can identify locations in the input image, e.g., bounding boxes or other geometric regions within the image, at which particular types of objects are depicted.

As yet another example, the task can be image segmentation and the output generated by the neural network can define for each pixel of the input image which of multiple categories the pixel belongs to.

More generally, however, the task can be any of a variety of tasks, including tasks that process inputs other than images.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks. Optionally, the network input can include an identifier for the individual natural language understanding task to be performed on the network input. As another example, the neural network can be configured to perform multiple individual image processing or computer vision tasks, i.e., by generating the output for the multiple different individual image processing tasks in parallel by processing a single input image.

The neural network data 112 includes, for each neural network in the set, data specifying the architecture of the neural network, i.e., data specifying the number of layers in the neural network and, for each layer, the operations performed by the layer and the connectivity of the layer, i.e., which layer or layers receive, as input, an output generated by the layer and which tensors are provided as input to the layer.

A tensor, as used in this specification, can be a scalar value, a vector of numeric values, a matrix of numeric values, or a higher-order array of numeric values.

For example, the neural network data 112 can be data representing a directed computational graph, where nodes in the graph represent layers of the neural network and an edge from a first node to a second node in the graph represents that the layer represented by the second node receives, as input, an output generated by the layer represented by the first node.

In some implementations, the system 100 or another system can optimize the neural network data 112 so that combinations of operations performed by different layers in an original architecture of a given neural network have been grouped into fused computations performed by a single, “fused” layer. For example, the system 100 can fuse layers that perform element-wise operations, e.g., element-wise multiplication or addition, or layers that perform data formatting operations with layers that perform. One example technique for performing this optimization is described in Norman P. Jouppi, Doe Hyun Yoon, George Kurian, Sheng Li, Nishant Patil, James Laudon, Cliff Young, and David Patterson. 2020. A Domain-Specific Supercomputer for Training Deep Neural Networks. Commun. ACM 63, 7 (June 2020), 67-78.

The system 100 also obtains objective function data 114 specifying an objective function that measures a performance of a hardware accelerator computer chip when performing inference for the target set of one or more neural networks and, optionally, constraints on the design of the hardware accelerator computer chip.

“Performing inference” for a neural network, as used in this specification, means processing a set of one or more inputs using the neural network to generate a respective output for each input for a machine learning task after the neural network has already been trained to perform the machine learning task.

The objective function data 114 can be provided by a user and the objective function can measure one or more aspects of the performance of the hardware accelerator computer chip in performing inference for the target set of one or more neural networks.

As a particular example, the objective function can measure one or more of: the power consumed by the computer chip when performing inference for each of the neural networks, the area of the computer chip, the latency of the computer chip when performing inference for each of the neural networks, or the throughput of the computer chip when performing inference for each of the neural networks.

When there are multiple neural networks in the target set, the objective function measures multiple different aspects of the performance of the chip, or both, the objective function can be a sum or a weighted sum of respective terms that each correspond to one aspect of performance for one of the neural networks in the set.

The system 100 then determines an architecture 150 for the hardware accelerator computer chip by performing an iterative search process. As will be described in more detail below, the architecture 150 specifies the hardware datapath for the hardware accelerator computer chip. Optionally, the system 100 can also determine a respective optimized fusion strategy for each of the neural networks in the target set when deployed on a hardware accelerator having the architecture 150.

At each iteration of the search process, a candidate generation system 120 within the system 100 determines a candidate set of hyperparameters 122 using an optimizer 130.

The candidate set of hyperparameters 122 define a candidate hardware datapath for the hardware accelerator computer chip from a search space of possible hardware datapaths for the hardware accelerator computer chip.

A hardware datapath may define hardware components, such as compute units and scratchpad memories, of a hardware accelerator computer chip, and in addition may define the connectivity between hardware components. Hence, a hardware datapath is a collection of hardware functional units that performs the data processing operations of the computer chip. For example, the functional units can include memory and processing elements that, in turn, can include systolic arrays of multiply-accumulate units (MACs) and, optionally, dedicated memory, vector processing units (VPUs), or both. Thus, the candidate set of hyperparameters 122 define which functional units are included in the hardware accelerator computer chip and how those functional units are arranged and connected on the surface of the hardware accelerator computer chip.

The hardware accelerator computer chip may also be associated with an execution schedule, which may comprise the compiler scheduling and hardware control logic that maps neural network operations, i.e., the operations performed by the layers of the neural network, onto the hardware datapath. Thus, the execution schedule defines the order in which the operations performed by the layers of the neural network are executed during the processing of a set of one or more inputs by the neural network.

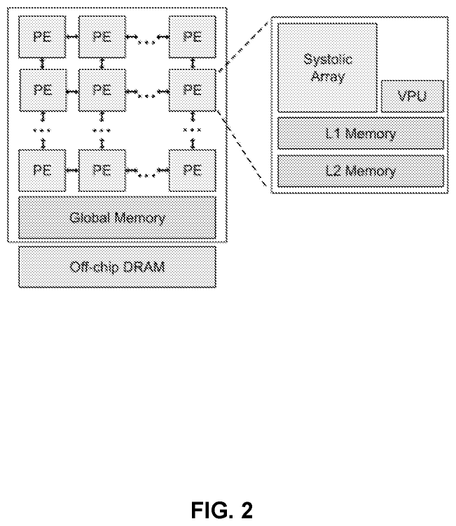

An example hardware datapath and an example search space of possible hardware datapaths are described below with reference to FIG. 2.

Optionally, the candidate generation system 120 also determines a respective fusion strategy for each of the one or more neural networks that is selected from a search space of possible fusion strategies for the neural network and that is optimized for a computer chip having the candidate hardware datapath.

The fusion strategy for a given neural network specifies which tensors that are associated with the layers of the neural network are stored in on-chip memory of the accelerator chip, e.g., shared memory that is shared across multiple processing elements or dedicated memory for one or more processing elements, and which tensors that are associated with the layers of the neural network are stored in off-chip memory, e.g., DRAM or other memory of a host device of the accelerator chip, when performing inference for the given neural network on an accelerator chip having a given datapath.

That is, in some implementations, the system 100 jointly optimizes both the datapath for the chip and the fusion strategies for the one or more neural networks, i.e., instead of first optimizing the datapath and then, once the datapath is fixed, determining a fusion strategy for each of the one or more neural networks given the fixed data path. Jointly optimizing the datapath and the fusion strategies can help ensure that the objective function accurately measures the optimized performance of any given datapath, i.e., by preventing a datapath that has a poor performance without an optimal fusion strategy but high quality performance with an optimal fusion strategy from being removed from consideration during the iterative search process.

The candidate generation system 120 can make use of any of a variety of optimizers 130 to propose the candidate sets of hyperparameters and, optionally, the optimized fusion strategy.

For example, the system 120 can use any existing black box optimizer that receives data specifying a search space of hyperparameter values and attempts to propose sets of hyperparameters from the search space that maximize the objective function, optionally while also adhering to a set of one or more constraints, given the objective function values for hyperparameters proposed at earlier search iterations.

For example, the optimizer 130 can be configured to, i.e., constrained to, generate candidate sets of hyperparameters that satisfy one or more constraints on an area of the computer chip. That is, the optimizer 130 can be constrained to generate candidate sets of hyperparameters that result in a chip that has a surface area that is less than a specified maximum area and, optionally, greater than a specified minimum area.

As another example, the optimizer 130 can be configured to, i.e., constrained to, generate candidate sets of hyperparameters that satisfy one or more constraints on the thermal design power of the computer chip. That is, the optimizer 130 can be constrained to generate candidate sets of hyperparameters that result in a chip that has a thermal design power that is less than a specified maximum power.

As a particular example, the system 120 can use the Vizier optimizer to propose candidate sets of hyperparameters for the search process. As another particular example, the system 100 can use the Optuna optimizer to propose candidate sets of hyperparameters for the search process.

When the fusion strategy is being jointly optimized, the system 120 can determine the optimized fusion strategy for a given candidate datapath in any of a variety of ways.

In some implementations, the optimizer 130 proposes both the hyperparameters and data specifying the fusion strategy. That is, the system 120 obtains from the optimizer 130 both the candidate set of hyperparameters 122 that define the hardware datapath for the hardware accelerator computer chip and data specifying the respective optimized fusion strategy for each of the one or more neural networks.

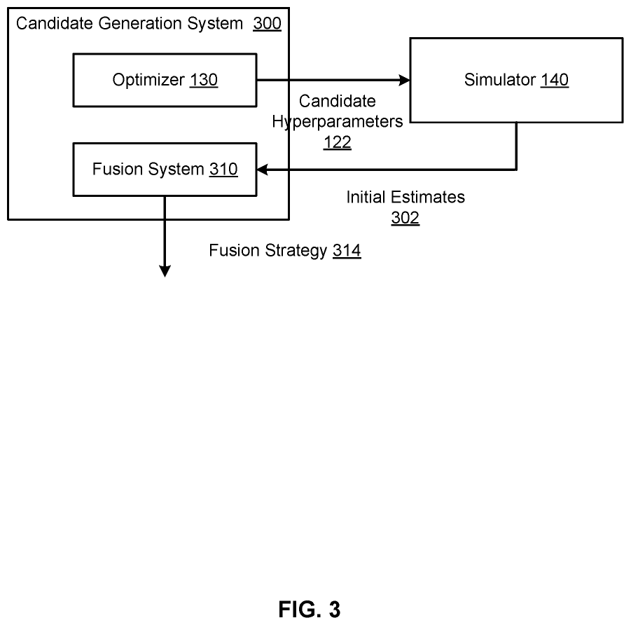

In some other implementations, the optimizer 130 proposes only the candidate set of hyperparameters 122 and the system 120 separately determines the fusion strategy for each of the neural networks once the candidate set of hyperparameters 122 have been proposed. This configuration of the system 120 is described in more detail below with reference to FIG. 3.

The system 120 determines a value 134 of the objective function for the candidate set of hyperparameters by, for each neural network in the set, simulating a performance of a hardware accelerator computer chip that has the hardware datapath defined by the candidate set of hyperparameters 132 when performing inference for the neural network. When the fusion strategy is being jointly optimized, the system 120 simulates the performance of a given neural network in accordance with the respective optimized fusion strategy for that neural network, i.e., with the optimized fusion strategy being used to determine which tensors are stored in on-chip (instead of off-chip) memory during inference.

That is, the system 100 uses a chip architecture simulator 140 to simulate the execution of the target neural networks to determine the required statistics, e.g., power estimates, latency estimates, throughput estimates, and so on, for each neural network and then determines the value 134 of the objective function from the statistics.

The chip architecture simulator 140 is a collection of one or more computer programs that simulates the performance of a computer chip having a given hardware datapath in executing a given workload.

The system 120 can use any appropriate chip architecture simulator that can simulate the performance of an accelerator chip after the chip has been fabricated to generate the values necessary to evaluate the objective function, e.g., power estimates, latency estimates, and so on. As an example, the system 120 can use a simulator 140 that is based on the Timeloop infrastructure, described in Parashar, et al, A Systematic Approach to DNN Accelerator Evaluation. As another example, the system 120 can use a simulator 140 that is based on the Systolic CNN Accelerator Simulator (SCALE-Sim) infrastructure, described in Samajdar, et al, SCALE-Sim: Systolic CNN Accelerator Simulator.

The system 120 provides the value 134 of the objective function to the optimizer 130 for use in generating a new candidate set of hyperparameters, i.e., at the next iteration.

By repeatedly performing these search iterations, the system 120 can cause the optimizer 130 to propose candidate sets of hyperparameters that result in higher objective function values.

Once a termination criterion has been satisfied, e.g., once a threshold amount of time has elapsed, a threshold number of search iterations has been performed, or a threshold number of search iterations have elapsed since the current highest objective function value was determined, the system 100 can select, as the final architecture 150, a final hardware datapath from the candidate hardware datapaths based on the respective values of the objective functions for the candidate hardware datapaths. For example, the system 100 can select the candidate hardware datapath having the highest objective function value.

The system 100 can receive the neural network data 112 specifying the target set of one or more neural networks and the data 114 specifying the objective function in any of a variety of ways.

As a particular example, the system 100 can receive the data from a user device, e.g., through an application programming interface (API) provided by the system or through a user interface provided for presentation on the user device.

The system 100 can then provide the data specifying the determined architecture 150 to the user device, e.g., through the API provided by the system.

As another particular example, the system 100 can be integrated as part of a chip design software tool and can provide the determined architecture 150 to another component of the chip design software tool, e.g., for further refinement, or to a control system for a chip fabrication tool that will fabricate a computer chip having the determined architecture. That is, once the system 100 has determined the final architecture 150, the system 100 can cause a chip having the final architecture 150 or an architecture that is based on the final architecture 150 but further refined by one or more other components to be fabricated, e.g., using conventional computer chip fabrication techniques.

FIG. 2 shows an example datapath 200 for a hardware accelerator chip.

As shown in FIG. 2, the example datapath 200 includes an array of processing elements (PEs) that are connected by an on-chip network, e.g., a mesh on-chip network. In the example of FIG. 2, the array of processing elements are arranged as a grid that has both x and y dimensions greater than 1.

Each PE, in turn, includes a systolic array made up of multiply-accumulate units (MACs) for performing multiplication, e.g., scalar-scalar, vector-matrix or matrix-matrix multiplication, a vector processing unit (VPU) for performing non-MAC vector operations, an L1 memory, and an L2 memory.

The datapath 200 also includes a Global Memory, e.g., SRAM memory. Additionally, some or all of the functional units in the datapath 200 can communicate with an off-chip DRAM memory.

The example datapath 200 is selected from a search space of possible datapaths.

More specifically, the search space of possible hardware datapaths includes possible hardware datapaths with both (i) different configurations of processing elements included in the computer chip and (ii) different memory configurations for on-chip memory included in the computer chip. That is, the candidate set of hyperparameters generated by the optimizer 130 specifies both a configuration of processing elements included in the computer chip and a configuration of the on-chip memory included in the computer chip. Allowing the optimizer to search for both processing element configuration and memory configurations allows the system 120 to consider a wider range of possible datapaths and increases how narrowly the final datapath can be tailored to the target set of neural networks.

As a particular example, each candidate set of hyperparameters can include (i) one or more hyperparameters that specify a dimensionality of the array of processing elements included in the computer chip from a set of a plurality of possible dimensionalities and (ii) one or more hyperparameters that specify a respective configuration of each of one or more memory buffers, i.e., the L1 and L2 memory buffers in the example datapath 200, included in the computer chip from a set of a plurality of possible configurations. Optionally, each candidate set of hyperparameters can also include (iii) one or more hyperparameters that specify a configuration of on-chip global memory included in the computer chip from a plurality of possible configurations.

More specifically, the one or more hyperparameters that specify a dimensionality of the array of processing elements included in the computer chip from a set of a plurality of possible dimensionalities can include a hyperparameter that specifies the value of the x dimension of the array from a set of possible x dimension values, a hyperparameter that specifies the value of the y dimension of the array from a set of possible y dimension values, or both.

Additionally, the one or more hyperparameters can also include one or more hyperparameters that specify the dimensionality of the systolic array included in each of the processing elements and the dimensionality of the VPU included in each of the processing elements. Modifying the dimensionality of the systolic array, for example, allows the optimizer 130 to optimize the systolic array for performing scalar or vector operations.

The one or more hyperparameters that specify a respective configuration of each of one or more memory buffers included in the computer chip from a set of a plurality of possible configurations can include, for the L1 memory buffer, a hyperparameter that specifies whether the L1 memory buffers for the processing elements are private to the processing elements or a single L1 memory buffer is shared across the processing element. The one or more hyperparameters can also include a hyperparameter that specifies respective sizes of one or more portions of the L1 memory buffer from among a plurality of different sizes. For the L2 memory buffer, the hyperparameters can specify not only whether the L2 memory buffer is private or shared, but also whether the L2 memory buffer is disabled, i.e., is removed from the datapath. Similarly, for the global memory, the hyperparameters can specify both the size of the global memory and whether the global memory is disabled, i.e., is removed from the datapath.

Optionally, in addition to specifying the hardware datapath the hyperparameters can also specify a native batch size for batches of inputs processed by the computer chip. That is, the hyperparameters can specify how many inputs for a given neural network the computer chip is configured to process in parallel.

An example set of hyperparameters and respective potential values for each of the hyperparameters are shown below in Table 1.

TABLE 1

| Parameter Name | Type | Potential Values |
|---|---|---|
| PEs_x_dim | int | 1 to 256, powers of 2 |
| PEs_y_dim | int | 1 to 256, powers of 2 |
| Systolic_array_x | int | 1 to 256, powers of 2 |
| Systolic_array_y | int | 1 to 256, powers of 2 |
| Vector_unit_multiplier | int | 1 to 16, powers of 2 |
| L1_buffer_config | enum | Private, Shared |
| L1_input_buffer_size | int | 1 KB to 1 MB, powers of 2 |
| L1_weight_buffer_size | int | 1 KB to 1 MB, powers of 2 |
| L1_output_buffer_size | int | 1 KB to 1 MB, powers of 2 |
| L2_buffer_config | enum | Disabled, Private, Shared |
| L2_input_buffer_multiplier | int | 1x to 128x, powers of 2 |
| L2_weight_buffer_multiplier | int | 1x to 128x, powers of 2 |
| L2_output_buffer_multiplier | int | 1x to 128x, powers of 2 |
| L3_global_buffer_size | int | 0 MB to 256 MB, powers of 2 |
| GDDR6_channels | int | 1 to 8, powers of 2 |
| Native_batch_size | int | 1 to 256, powers of 2 |

FIG. 3 shows the operation of a candidate generation system 300 during a search iteration. The candidate generation system 300 is an example of the candidate generation system 120 of FIG. 1.

As described above, at each search iteration, the optimizer 130 generates a candidate set of hyperparameters 122 that define a datapath for the hardware accelerator computer chip.

For each neural network in the target set, the candidate generation system 300 uses the computer chip performance simulator 140 to simulate operation of each layer of the neural network to generate an initial estimate 302 of performance statistics for the layer when executed on the hardware accelerator computer chip having the candidate hardware datapath.

Optionally, prior to using the simulator 140, the system 300 can perform pre-processing to optimize certain compute-intensive operations performed by the target set of neural networks. For example, the system 300 can optimize two-dimensional convolutions for execution on the datapath, e.g., by performing tensor padding optimization.

Additionally, prior to generating the initial estimates 302, the system 300 can, for each neural network, determine an optimized execution schedule for the layers of the neural network to optimize at least an execution time of the neural network on the computer chip. Thus, in these implementations, the initial estimates of the performance statistics are determined when the model is executed in accordance with the optimized schedule. For example, the simulator 140 can be configured to optimize the execution schedule for the layers prior to computing the initial estimates 302. Optionally, the system 300 can constrain the schedule optimization to fall within one or more predetermined schemes for loading inputs and weights into the systolic arrays of the processing elements of the datapath, e.g., weight stationary or output stationary schemes.

A fusion system 310 within the candidate generation system 300 then determines a respective fusion strategy 314 for the neural network that optimizes an execution time of the neural network on the hardware accelerator computer chip having the candidate hardware datapath based on the initial estimates 302 for each of the layers.

Generally, the initial estimates 302 for a given layer measure the execution times for the layer when the tensors associated with the layer are stored in on-chip memory and when the tensors associated with the layer are stored in off-chip memory. As will be described in more detail below; the tensors associated with a given layer generally include an input activation tensor, an output activation tensor, and a weight tensor for the layer.

The initial estimates 302 can also measure the time required to load each of the tensors associated with the layer from off-chip memory. Optionally, the initial estimates 302 can also measure the nominal usage of the on-chip memory of each of the layers of the neural network, i.e., the amount of on-chip memory used by the execution of the layer when all of the tensors associated with the layer are stored in off-chip memory.

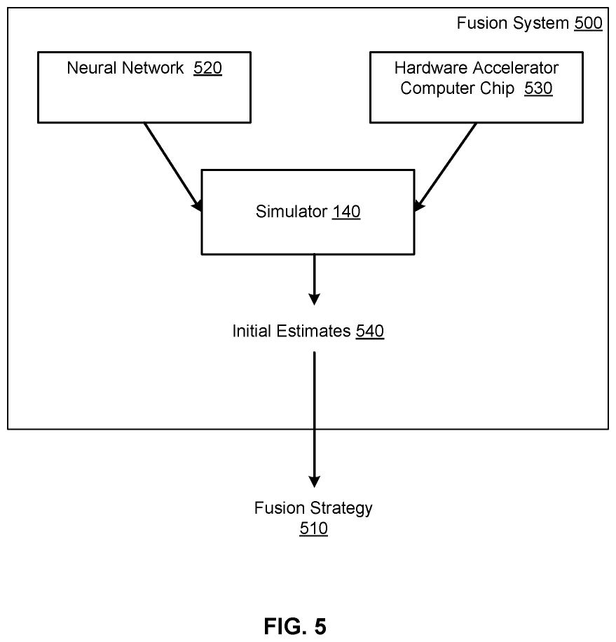

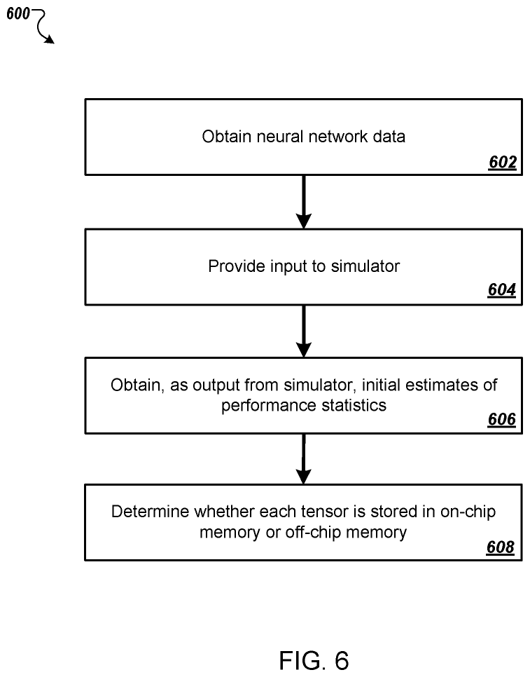

As a particular example, the fusion system 310 can use the initial estimates 302 for each of the layers to solve a constrained optimization using integer linear programming. Determining a fusion strategy by solving a constrained optimization using integer linear programming is described in more detail below with reference to FIGS. 5 and 6.

Once the fusion system 310 has determined the optimized fusion strategies 314 for each of the neural networks, the system 300 can use the simulator 140 to determine objective function value 142 for the candidate set of hyperparameters 142 when each neural network is executed in accordance with the corresponding optimized fusion strategy 314.

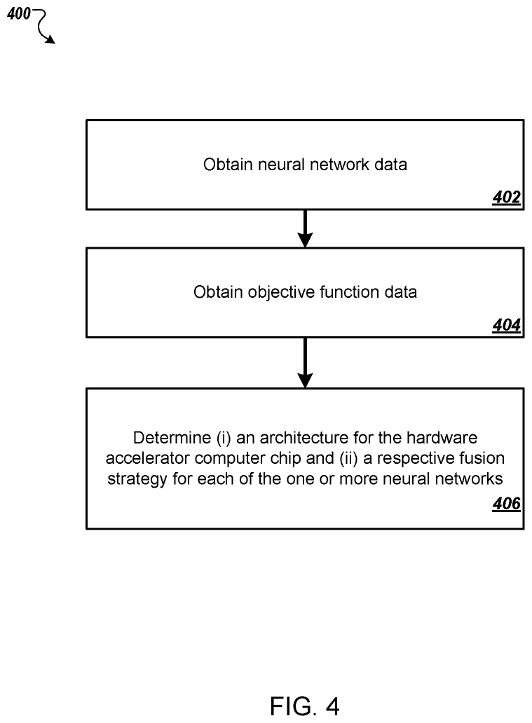

FIG. 4 is a flow diagram of an example process 400 for determining an architecture for a hardware accelerator computer chip. For convenience, the process 400 will be described as being performed by a system of one or more computers located in one or more locations. For example, an accelerator architecture search system, e.g., the system 100 of FIG. 1, appropriately programmed, can perform the process 400.

The system obtains neural network data specifying a target set of one or more neural networks (step 402).

The system obtains objective function data specifying an objective function that measures a performance of a hardware accelerator computer chip when performing inference for the target set of one or more neural networks (step 404). As described above and in more detail below, each of the one or more neural networks has a respective set of associated tensors. The respective set of associated tensors for a given neural network includes one or more of (i) one or more weight tensors each representing weights of a respective layer of the neural network, (ii) one or more input activation tensors each representing an input to a respective layer of the neural network, or (ii) one or more output activation tensors each representing an output of a respective layer of the neural network.

The system determines (i) an architecture for the hardware accelerator computer chip and (ii) a respective fusion strategy for each of the one or more neural networks when deployed on the hardware accelerator computer chip having the determined architecture (step 406). The respective fusion strategy for each of the one or more neural networks specifies, for each tensor in the set of associated tensors for the neural network, whether or not the tensor is stored in on-chip memory of the hardware accelerator computer chip during processing of inputs using the neural network. That is, the respective fusion strategy for each of the one or more neural networks specifies, for each tensor in the set of associated tensors for the neural network, whether the tensor is stored in on-chip memory of the hardware accelerator computer chip or off-chip memory, e.g., memory of a host device for the hardware accelerator computer chip, during processing of inputs using the neural network.

As part of the determining, the system repeatedly performs search iterations. At each search iteration, the system determines (i) a candidate set of hyperparameters that define a candidate hardware datapath for the hardware accelerator computer chip from a search space of possible hardware datapaths for the hardware accelerator computer chip and (ii) a respective optimized fusion strategy for each of the one or more neural networks from a search space of possible optimized fusion strategies for the neural network when deployed on a hardware accelerator chip having an architecture specified by the candidate hardware datapath. The system then determines a value of the objective function for the candidate hardware datapath by, for each neural network in the set, simulating a performance of a candidate hardware accelerator computer chip that has the hardware datapath defined by the candidate set of hyperparameters when performing inference for the neural network in accordance with the respective optimized fusion strategy for the neural network.

After performing the search iterations, i.e., after a termination criterion for terminating performing the search iterations has been satisfied, the system selects a final hardware datapath for the hardware accelerator computer chip from the candidate hardware datapaths based on the respective values of the objective functions for the candidate hardware datapaths.

FIG. 5 shows an example fusion system 500. The fusion system 500 is an example of a system implemented as computer programs on one or more computers in one or more locations, in which the systems, components, and techniques described below can be implemented.

The fusion system 500 determines a fusion strategy 510 for a neural network 520 that is deployed on a hardware accelerator computer chip 530.

The neural network 520 can be any appropriate neural network configured to perform any appropriate machine learning task. For example, the neural network 520 can be configured to perform one of the machine learning tasks described above with reference to FIG. 1.

The fusion strategy 510 determines how to store input activation tensors, output activation tensors and weight tensors of the layers of the neural network 520 that is deployed on the hardware accelerator computer chip 530.

The input activation tensor of a given layer is the tensor that includes the input activations, i.e., the layer inputs that are processed by the layer.

The output activation tensor of a given layer is the tensor that includes the output activations, i.e., the layer outputs that are generated by the layer by processing the values in the input activation tensor.

A weight tensor of a given layer is a tensor that includes the weights that are applied to the input activations by the given layer as part of generating the output activations. In some cases, a layer can have a single weight tensor, e.g., a tensor that includes the weights in a weight matrix of the layer or the weights in a convolutional kernel of the layer. In some other cases, a layer can have multiple weight tensors, e.g., one tensor that includes the weights in the weight matrix or the convolutional kernel of the layer and another tensor that includes the bias values in a bias vector or matrix for the layer.

That is, the system 100 determines a fusion strategy 510 that specifies, for each of these tensors, whether the tensor is to be stored in off-chip memory or in on-chip memory of the accelerator chip 530 while performing inference while the neural network 520 is deployed on the hardware accelerator chip 530.

The hardware accelerator chip 530 can be any appropriate special-purpose hardware chip, e.g., an ASIC or an FPGA, that has on-chip memory. Examples of hardware accelerators include TPUs, GPUs, Eyeriss chips, EdgeTPUs, and Simba chips.

The on-chip memory include a shared global memory that is accessible by all of the processing elements on the accelerator chip 530, dedicated memory that is only accessible by one of the processing elements on the accelerator chip 530, or both. Examples of shared and dedicated memory are described above with reference to FIG. 2.

In some cases, the described process for determining a fusion strategy 510 can be performed after the hardware datapath of the hardware accelerator is fixed, e.g., in order to optimize the performance of the neural network 520 when deployed on a specified hardware accelerator that has already been fabricated.

In some of these cases, once the system 500 has determined the fusion strategy 510, the system 500 can perform inference for the neural network 520 while the neural network 520 is deployed on the hardware accelerator computer chip 530 in accordance with the determined fusion strategy 510. While performing inference for the neural network 520 while the neural network 520 is deployed on the hardware accelerator computer chip 530, the system 500 can, for each tensor that was determined to be stored in the on-chip memory, store the tensor in on-chip memory, and, for each tensor that was determined to be stored in the off-chip memory, store the tensor in off-chip memory.

In others of these cases, once the system 500 has determined the fusion strategy 510, the system 500 can provide data specifying the fusion strategy 510 to another system, e.g., to the host device for the chip 530, that controls the chip 530 to perform inference for the neural network 520 in accordance with the determined fusion strategy 510.

In some other cases, the described process for determining the fusion strategy can be performed while an architecture search system, e.g., the system 100 of FIG. 1, searches for an optimized hardware datapath for an accelerator on which to deploy the neural network. In these cases, the hardware accelerator described below is one with a candidate hardware datapath that is being evaluated as part of the search process. In these cases, once the system 510 has determined the fusion strategy 510, the system 510 can provide data specifying the fusion strategy 510 to the architecture search system for use in performing the architecture search.

More specifically, the system 510 determines the fusion strategy 510 using the simulator 140. That is, the system 510 provides, as input, as input to the computer chip performance simulator 140, data specifying the neural network 520 and data specifying the hardware datapath of the hardware accelerator 530. The system obtains, as output from the computer chip performance simulator 140 and for each of the plurality of neural network layers, a respective initial estimate 540 of performance statistics for the layer when the neural network is executed on the hardware accelerator computer chip.

The system 500 then uses these initial estimates 540 to determine the fusion strategy 510. That is, the system 500 determines, from the respective initial estimates 540 for the neural network layers and for each tensor that is associated with each of the plurality of neural networks layers, whether the tensor is stored in the on-chip memory or in off-chip memory while performing inference for the neural network 520 while the neural network 520 is deployed on the hardware accelerator computer chip 530.

Because the fusion strategy is tailored to performing inference, i.e., and intermediate outputs can be discarded after they are consumed, once an input activation tensor that is stored in on-chip memory according to the fusion strategy has been processed by the corresponding layer, the input activation tensor and the corresponding output activation tensor used to generate the input tensor can be discarded from on-chip memory. Weight tensors, however, can be “pinned” to the on-chip memory, i.e., can be stored to reuse across multiple inference requests. Thus, weight tensors that are stored in the on-chip memory according to the fusion strategy are not discarded once the corresponding layer has finished processing for a given inference request.

Optionally, prior to generating the initial estimates 540, the system 500 can determine or, equivalently, cause the simulator 140 to determine an execution schedule for executing the operations of the plurality of neural network layers as described above. The system 500 can then provide, as input to the computer chip performance simulator 140, the data specifying the neural network, the data specifying the hardware datapath of the hardware accelerator, and data specifying the schedule to cause the simulator 140 to generate the respective initial estimates 540 as estimates of the performance statistics when the operations are performed according to the schedule during execution of the neural network on the hardware accelerator computer chip.

More specifically, the system 500 uses the initial estimates 540 to determine the fusion strategy 510 by solving a constrained optimization using integer linear programming. Determining a fusion strategy by solving a constrained optimization using integer linear programming is described in more detail below with reference to FIG. 6.

FIG. 6 is a flow diagram of an example process 600 for determining a fusion strategy for a neural network. For convenience, the process 600 will be described as being performed by a system of one or more computers located in one or more locations. For example, a fusion system, e.g., the fusion system 500 of FIG. 5, appropriately programmed, can perform the process 600.

The system obtains neural network data specifying a neural network to be deployed on a hardware accelerator computer chip (step 602).

As described above, the hardware accelerator has on-chip memory and has a particular hardware datapath and the neural network includes a plurality of neural network layers.

Each of the neural network layers have an associated set of tensors that includes (i) a weight tensor for the neural network layer, (ii) an input activation tensor for the neural network layer, and (iii) an output activation tensor for the neural network layer.

More specifically, each neural network layer is configured to receive the respective input activation tensor for the neural network layer and to process the respective input activation tensor for the neural network layer in accordance with the respective weight tensor for the neural network layer to generate the respective output activation tensor for the neural network layer. For example, a given layer can be a fully-connected layer that performs a matrix multiplication between the input activation tensor for the layer and a weight matrix for the layer or a convolutional layer that performs a convolution between the input activation tensor for the layer and a kernel of weights for the layer as part of generating the activation output for the layer.

In some implementations, to account for layers that perform operations that do not require weight tensors, e.g., element-wise multiplication or other operations, data formatting, and so on, the system or another system can optimize the neural network data so that combinations of operations have been grouped into fused computations performed by a single, “fused” layer. One example technique for performing this optimization is described in Norman P. Jouppi, Doe Hyun Yoon, George Kurian, Sheng Li, Nishant Patil, James Laudon, Cliff Young, and David Patterson. 2020. A Domain-Specific Supercomputer for Training Deep Neural Networks. Commun. ACM 63, 7 (June 2020), 67-78.

The system provides, as input to a computer chip performance simulator, the data specifying the neural network and data specifying the hardware datapath of the hardware accelerator (step 604).

The system obtains, as output from the computer chip performance simulator and for each of the plurality of neural network layers, a respective initial estimate of performance statistics for the layer when the neural network is executed on the hardware accelerator computer chip, i.e., on a chip having the hardware datapath that was provided to the simulator (step 606).

Example of performance statistics for a given layer that can be generated by the computer chip performance simulator are described below.

The system determines, from the respective initial estimates for the neural network layers and for each tensor that is associated with each of the plurality of neural networks layers, whether the tensor is stored in the on-chip memory or in off-chip memory while performing inference for the neural network while the neural network is deployed on the hardware accelerator computer chip (step 608).

In particular, the system can determine, from the respective initial estimates, a fusion strategy that minimizes an objective subject to one or more constraints. As a particular example, the objective to be minimized can be the sum of respective execution times for each of the plurality of neural network layers. The execution time for a given layer is the time required for the hardware accelerator chip to perform the operations that are required to generate the output activation tensor for the given layer from the input activation tensor for the given layer, e.g., the time required to load the input activation tensor and the weight tensor for the given layer and to process the input activation tensor in accordance with the weight tensor. By minimizing the sum of execution times for the layers, the system minimizes the total time required to perform inference for a given input to the neural network.

To determine the fusion strategy, the system can solve the constrained optimization through integer linear programming using the respective initial estimates. That is, the system can formulate the constrained optimization as an integer linear program that requires assigning either a first integer, e.g., zero, or a second integer, e.g., one, to each tensor associated with any of the layers of the neural network. Tensors that are assigned the first integer are stored in off-chip memory while tensors that are assigned the second integer are stored in on-chip memory. The system can then use any appropriate integer linear programming (ILP) solver to solve the linear program, i.e., to assign either the first or second integer to each of the tensors.

The system can employ any of a variety of constraints that are dependent on the performance statistics that are estimated by the simulator.

For example, the performance statistics that are estimated by the simulator can include, for each of the plurality of neural network layers, a respective minimum execution time for the neural network layer when the input and output activation tensors for the layer are assigned to the on-chip memory. In this example, the one or more constraints can include a first constraint that is based on these minimum execution times. In particular, the first constraint can specify that, for each of the plurality of neural network layers, the respective execution time is greater than or equal to the respective minimum execution time for the neural network layer. This constraint ensures that the linear program solver does not determine that the execution time for any given layer is less than the minimum possible execution time for the layer, i.e., because execution times are minimized when both input and output activations for the layer are assigned to the on-chip memory and do not need to be written to or read from off-chip memory.

As another example, the performance statistics generated by the simulator can include, for each of the plurality of neural network layers, a respective maximum execution time for the neural network layer when the input and output activation tensors for the neural network layer are assigned to off-chip memory and, for each of the tensors associated with the neural network layer, a respective loading time required to load the tensor from off-chip memory. In this example the constraints can include a second constraint that is based on the maximum execution times and loading times. In particular, the second constraint can specify that, for each of the plurality of neural network layers, the respective execution time is greater than or equal to the difference between (i) the respective maximum execution time for the neural network layer and (ii) a product of the respective times required to load each tensor that is associated with the neural network layer and that is assigned to on-chip memory by the fusion strategy. That is, this constraint ensures that the linear program solver does not determine that a given fusion strategy that stores one or more of the tensors for a given layer in the on-chip memory decreases the execution time for the given layer by more than the savings in loading time that are achieved by storing the one or more tensors in on-chip memory rather than in off-chip memory.

As yet another example, the performance statistics generated by the simulator can include any of various statistics characterizing the usage of the on-chip memory during the processing of each of the neural network layers. In this example, the constraints can include a third constraint that is based on these statistics. In particular, the third constraint can specify that the respective usage of the on-chip memory during the processing of each neural network layer does not exceed the capacity of the on-chip memory.

As a particular example, the performance statistics generated by the simulator can specify, for each of the layers, (i) a nominal memory usage for the processing of the neural network layer and (ii) a respective additional memory usage for each tensor associated with the neural network layer that specifies an additional amount of the on-chip memory that is used when the tensor is assigned to the on-chip memory. The nominal memory usage represents the amount of the on-chip memory that used by the processing of the neural network layer, e.g., to store intermediate values generated during the processing of the layer, even when none of the tensors associated with the layer are stored in the on-chip memory. In this particular example, the respective usage for each particular neural network layer for a given fusion strategy can be equal to the sum of (i) the nominal memory usage for the particular neural network layer, (ii) the sum of respective additional memory usages for each tensor associated with the particular neural network layer that is assigned to the on-chip memory by the fusion strategy and (iii) a sum of, for each other neural network layer in the plurality of neural network layers other than the particular neural network layer whose weight tensor is assigned to the on-chip memory by the fusion strategy, respective memory usages of the respective weight matrices for the other neural network layers. That is, because weight tensors are loaded into the on-chip memory prior to the

The system can also employ any of a variety of constraints that are not dependent on the initial estimates generated by the simulator.

For example, the one or more constraints can include a fourth constraint specifying that, for each particular neural network layer of the plurality of neural network layers, if the respective output activation tensor for the particular neural network layer is assigned to the on-chip memory by the fusion strategy, the respective input activation tensor for each neural network layer that receives, as input, the output of the particular neural network layer is also assigned to the on-chip memory by the fusion strategy. That is, this constraint ensures that if an output activation tensor for a given layer is assigned to the on-chip memory, each input activation tensor that is generated from the output activation tensor is also assigned to the on-chip memory. This constraint can prevent the fusion strategy from causing a tensor that is not immediately consumed by another layer from being stored in the on-chip memory.

As another example, the one or more constraints include a fifth constraint specifying that, for each particular neural network layer of the plurality of neural network layers, if the respective output activation tensor for the particular layer is assigned to the off-chip memory by the fusion strategy, the respective input activation tensor for each layer that receives as input the output of the particular neural network layer is also assigned to the off-chip memory by the fusion strategy. That is, this constraint ensures that if an output activation tensor for a given layer is assigned to the off-chip memory, each input activation tensor that is generated from the output activation tensor is also assigned to the off-chip memory. This constraint can prevent the fusion strategy from generating an inconsistent assignment of tensors, i.e., from assigning, to the on-chip memory, a tensor that is composed of values that have been assigned to the off-chip memory.

As another example, the one or more constraints can include a sixth constraint specifying that, for each particular neural network layer of the plurality of neural network layers, if the respective output activation tensor for the particular neural network layer is assigned to the on-chip memory by the fusion strategy, the respective input activation tensor for at least one neural network layer that receives as input the output of the particular neural network layer is also assigned to the on-chip memory by the fusion strategy. This constraint can prevent the fusion strategy from generating an inconsistent assignment of tensors, i.e., from assigning, to the on-chip memory, a tensor that is not used to generate any other tensors for other tensors that will also be stored in the on-chip memory.

As another example, the one or more constraints can include a seventh constraint specifying that, for each particular neural network layer of the plurality of neural network layers, if the respective input activation tensor for the particular neural network layer is assigned to the on-chip memory by the fusion strategy, the neural network layer that generates the input to the particular neural network layer must be executed immediately before the particular neural network layer. This constraint can prevent the fusion strategy from requiring that the accelerator store a given input tensor in the on-chip memory that is not used by the layer currently being executed by the accelerator.

The set of one or more constraints can include any combination of one or more of the above seven constraints and, in some cases, can include all seven of the above constraints. Moreover, each of the above constraints can be represented as a linear constraint on the first and second values for the tensors associated with the layers, on the execution times for the layer, or both.

As a particular example, a linear program that maximizes the sum of execution times for the layers subject to all of the constraints can be represented as the following integer linear program:

$$\begin{matrix}\begin{matrix}{min}_{{p}_{i}^{k}} & {\sum }_{i ∈ V} {T}_{i}\end{matrix} \\ \begin{matrix}s . t . & {T}_{i} \geq {T}_{i}^{min} \\ & {T}_{i} \geq {T}_{i}^{max} - {\sum }_{k ∈ {D}_{i}} {i}_{i}^{k} \cdot {p}_{i}^{k} \\ & {c}_{OM} \geq {B}_{i} + {\sum }_{k ∈ {D}_{i}} {d}_{i}^{k} \cdot {p}_{i}^{k} + {\sum }_{j ∈ V , j \neq i} {w}_{j} \cdot {p}_{j}^{w} \\ & \begin{matrix}{p}_{i}^{O} \geq {p}_{j}^{I} & ∀\end{matrix} j ∈ {F}_{out} ( i ) \\ & {\sum }_{j ∈ {F}_{out} ( i )} {p}_{j}^{I} \geq {p}_{i}^{O} \\ & M \cdot ( 1 - {p}_{i}^{I} ) \geq o ( i ) - o ( {F}_{in} ( i ) ) - 1 \\ & {p}_{i}^{k} ∈ \{ 0 , 1 \} ∀ k ∈ {D}_{i}\end{matrix}\end{matrix} \begin{matrix}{min}_{{p}_{i}^{k}} & {\sum }_{i ∈ V} {T}_{i}\end{matrix}$$

where the variable pᵢ^{k} is a binary decision variable indicating whether the tensor of type k∈Dₜ for layer i is to be placed in the on-chip memory (if equal to 1), Dₜ is the set of types of associated tensors for any of the layers, the variable Tᵢ represents the optimized execution time for layer i as a function of pᵢ^{k} for all k∈Dₜ, Tᵢ^{min} and Tᵢ^{max} are the execution times for layer i when the inputs and outputs of the layer are pinned exclusively in the on-chip memory and off-chip memory, respectively, tᵢ^{k} is time to access layer i's tensor of type k from off-chip memory, CGM is the capacity of the Global Memory (on-chip memory), e.g., in bytes, Bi is the nominal memory usage of layeri, dᵢ^{k} is the difference between the size of layer i's tensor of type k and the corresponding tile size allocated on the global buffer if we were to assume the tensor is being streamed from/to off-chip memory, Wⱼ is the size of layer j's weight tensor, and M≥n−1 is a fixed constant.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages: and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices: magnetic disks, e.g., internal hard disks or removable disks: magneto optical disks: and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback: and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining data specifying a neural network to be deployed on a hardware accelerator computer chip, wherein:
the hardware accelerator comprises on-chip memory and has a particular hardware datapath,
the neural network comprises a plurality of neural network layers,
each neural network layer has an associated set of tensors that comprises (i) a weight tensor for the neural network layer, (ii) an input activation tensor for the neural network layer, and (iii) an output activation tensor for the neural network layer, and
each neural network layer is configured to receive the respective input activation tensor for the neural network layer and to process the respective input activation tensor for the neural network layer in accordance with the respective weight tensor for the neural network layer to generate the respective output activation tensor for the neural network layer;
providing, as input to a computer chip performance simulator, the data specifying the neural network and data specifying the hardware datapath of the hardware accelerator;
obtaining, as output from the computer chip performance simulator and for each of the plurality of neural network layers, a respective initial estimate of performance statistics for the layer when the neural network is executed on the hardware accelerator computer chip; and
determining, from the respective initial estimates for the neural network layers and for each tensor that is associated with each of the plurality of neural networks layers, whether the tensor is stored in the on-chip memory or in off-chip memory while performing inference for the neural network while the neural network is deployed on the hardware accelerator computer chip.

2. The method of claim 1, further comprising:
determining a schedule for executing the operations of the plurality of neural network layers, wherein providing, as input to a computer chip performance simulator, the data specifying the neural network and data specifying the hardware datapath of the hardware accelerator comprises:
providing, as input to a computer chip performance simulator, the data specifying the neural network, the data specifying the hardware datapath of the hardware accelerator, and data specifying the schedule, and wherein the respective initial estimates are estimates of the performance statistics when the operations are performed according to the schedule during execution of the neural network on the hardware accelerator computer chip.

3. The method of claim 1, wherein
determining, from the respective initial estimates and for each tensor that is associated with each of the plurality of neural networks layers, whether the tensor is stored in the on-chip memory or in off-chip memory while performing inference for the neural network while the neural network is deployed on the hardware accelerator computer chip comprises:
determining, from the respective initial estimates, a fusion strategy that minimizes a sum of respective execution times for each of the plurality of neural network layers subject to one or more constraints, the fusion strategy assigning each tensor that is associated with each of the plurality of neural network layers to either the on-chip memory or the off-chip memory.

4. The method of claim 3, wherein:
the initial estimates include, for each of the plurality of neural network layers, a respective minimum execution time for the neural network layer when the input and output activation tensors for the layer are assigned to the on-chip memory; and
the one or more constraints include a first constraint specifying that, for each of the plurality of neural network layers, the respective execution time is greater than or equal to the respective minimum execution time for the neural network layer.

5. The method of claim 3, wherein:
the initial estimates include, for each of the plurality of neural network layers:
a respective maximum execution time for the neural network layer when the input and output activation tensors for the neural network layer are assigned to off-chip memory, and
for each of the tensors associated with the neural network layer, a respective time required to load the tensor from off-chip memory; and
the one or more constraints include a second constraint specifying that, for each of the plurality of neural network layers, the respective execution time is greater than or equal to a difference between (i) the respective maximum execution time for the neural network layer and (ii) a product of the respective times required to load each tensor that is associated with the neural network layer and that is assigned to on-chip memory by the fusion strategy.

6. The method of claim 3, wherein the one or more constraints include:
a third constraint specifying that a respective usage of the on-chip memory during the processing of each neural network layer does not exceed a capacity of the on-chip memory.

7. The method of claim 6, wherein:
the initial estimates include, for each of the plurality of neural network layers:
a nominal memory usage for the processing of the neural network layer; and
a respective additional memory usage for each tensor associated with the neural network layer that specifies an additional amount of the on-chip memory that is used when the tensor is assigned to the on-chip memory, and
the respective usage for each particular neural network layer is equal to a sum of (i) the nominal memory usage for the particular neural network layer, (ii) a sum of respective additional memory usages for each tensor associated with the particular neural network layer that is assigned to the on-chip memory by the fusion strategy and (iii) a sum of, for each other neural network layer in the plurality of neural network layers other than the particular neural network layer whose weight tensor is assigned to the on-chip memory by the fusion strategy, respective memory usages of the respective weight matrices for the other neural network layers.

8. The method of claim 3, wherein the one or more constraints include a fourth constraint specifying that, for each particular neural network layer of the plurality of neural network layers, if the respective output activation tensor for the particular neural network layer is assigned to the on-chip memory by the fusion strategy, the respective input activation tensor for each neural network layer that receives as input the output of the particular neural network layer is also assigned to the on-chip memory by the fusion strategy.

9. The method of claim 3, wherein the one or more constraints include a fifth constraint specifying that, for each particular neural network layer of the plurality of neural network layers:
if the respective output activation tensor for the particular layer is assigned to the off-chip memory by the fusion strategy, the respective input activation tensor for each layer that receives as input the output of the particular neural network layer is also assigned to the off-chip memory by the fusion strategy.

10. The method of claim 3, wherein the one or more constraints include a sixth constraint specifying that, for each particular neural network layer of the plurality of neural network layers:
if the respective output activation tensor for the particular neural network layer is assigned to the on-chip memory by the fusion strategy, the respective input activation tensor for at least one neural network layer that receives as input the output of the particular neural network layer is also assigned to the on-chip memory by the fusion strategy.

11. The method of claim 3, wherein the one or more constraints include a seventh constraint specifying that, for each particular neural network layer of the plurality of neural network layers:
if the respective input activation tensor for the particular neural network layer is assigned to the on-chip memory by the fusion strategy, the neural network layer that generates the input to the particular neural network layer must be executed immediately before the particular neural network layer.

12. The method of claim 3, wherein:
determining, from the respective initial estimates, a fusion strategy that minimizes a sum of respective execution times for each of the plurality of neural network layers subject to one or more constraints comprises determining the fusion strategy through integer linear programming using the respective initial estimates.

13. The method of claim 1, further comprising:
performing inference for the neural network while the neural network is deployed on the hardware accelerator computer chip, comprising:
while performing inference for the neural network while the neural network is deployed on the hardware accelerator computer chip:
for each tensor that was determined to be stored in the on-chip memory, storing the tensor in on-chip memory and
for each tensor that was determined to be stored in the off-chip memory, storing the tensor in off-chip memory.

14. (canceled)

15. One or more non-transitory computer-readable storage media storing instructions that when executed by one or more computers cause the one or more computers to perform operations comprising:
obtaining data specifying a neural network to be deployed on a hardware accelerator computer chip, wherein:
the hardware accelerator comprises on-chip memory and has a particular hardware datapath,
the neural network comprises a plurality of neural network layers,
each neural network layer has an associated set of tensors that comprises (i) a weight tensor for the neural network layer, (ii) an input activation tensor for the neural network layer, and (iii) an output activation tensor for the neural network layer, and
each neural network layer is configured to receive the respective input activation tensor for the neural network layer and to process the respective input activation tensor for the neural network layer in accordance with the respective weight tensor for the neural network layer to generate the respective output activation tensor for the neural network layer;
providing, as input to a computer chip performance simulator, the data specifying the neural network and data specifying the hardware datapath of the hardware accelerator;
obtaining, as output from the computer chip performance simulator and for each of the plurality of neural network layers, a respective initial estimate of performance statistics for the layer when the neural network is executed on the hardware accelerator computer chip; and
determining, from the respective initial estimates for the neural network layers and for each tensor that is associated with each of the plurality of neural networks layers, whether the tensor is stored in the on-chip memory or in off-chip memory while performing inference for the neural network while the neural network is deployed on the hardware accelerator computer chip.

16. A system comprising one or more computers and one or more storage devices storing instruction that when executed by the one or more computer cause the one or more computers to perform operations comprising:
obtaining data specifying a neural network to be deployed on a hardware accelerator computer chip, wherein:
the hardware accelerator comprises on-chip memory and has a particular hardware datapath,
the neural network comprises a plurality of neural network layers,
each neural network layer has an associated set of tensors that comprises (i) a weight tensor for the neural network layer, (ii) an input activation tensor for the neural network layer, and (iii) an output activation tensor for the neural network layer, and
each neural network layer is configured to receive the respective input activation tensor for the neural network layer and to process the respective input activation tensor for the neural network layer in accordance with the respective weight tensor for the neural network layer to generate the respective output activation tensor for the neural network layer;
providing, as input to a computer chip performance simulator, the data specifying the neural network and data specifying the hardware datapath of the hardware accelerator;
obtaining, as output from the computer chip performance simulator and for each of the plurality of neural network layers, a respective initial estimate of performance statistics for the layer when the neural network is executed on the hardware accelerator computer chip; and
determining, from the respective initial estimates for the neural network layers and for each tensor that is associated with each of the plurality of neural networks layers, whether the tensor is stored in the on-chip memory or in off-chip memory while performing inference for the neural network while the neural network is deployed on the hardware accelerator computer chip.

17. The system of claim 16, the operations further comprising:
determining a schedule for executing the operations of the plurality of neural network layers, wherein providing, as input to a computer chip performance simulator, the data specifying the neural network and data specifying the hardware datapath of the hardware accelerator comprises:
providing, as input to a computer chip performance simulator, the data specifying the neural network, the data specifying the hardware datapath of the hardware accelerator, and data specifying the schedule, and wherein the respective initial estimates are estimates of the performance statistics when the operations are performed according to the schedule during execution of the neural network on the hardware accelerator computer chip.

18. The system of claim 18, wherein
determining, from the respective initial estimates and for each tensor that is associated with each of the plurality of neural networks layers, whether the tensor is stored in the on-chip memory or in off-chip memory while performing inference for the neural network while the neural network is deployed on the hardware accelerator computer chip comprises:
determining, from the respective initial estimates, a fusion strategy that minimizes a sum of respective execution times for each of the plurality of neural network layers subject to one or more constraints, the fusion strategy assigning each tensor that is associated with each of the plurality of neural network layers to either the on-chip memory or the off-chip memory.

19. The system of claim 18, wherein:
the initial estimates include, for each of the plurality of neural network layers, a respective minimum execution time for the neural network layer when the input and output activation tensors for the layer are assigned to the on-chip memory; and
the one or more constraints include a first constraint specifying that, for each of the plurality of neural network layers, the respective execution time is greater than or equal to the respective minimum execution time for the neural network layer.

20. The system of claim 18, wherein:
the initial estimates include, for each of the plurality of neural network layers:
a respective maximum execution time for the neural network layer when the input and output activation tensors for the neural network layer are assigned to off-chip memory, and
for each of the tensors associated with the neural network layer, a respective time required to load the tensor from off-chip memory; and
the one or more constraints include a second constraint specifying that, for each of the plurality of neural network layers, the respective execution time is greater than or equal to a difference between (i) the respective maximum execution time for the neural network layer and (ii) a product of the respective times required to load each tensor that is associated with the neural network layer and that is assigned to on-chip memory by the fusion strategy.

21. The system of claim 18, wherein the one or more constraints include:
a third constraint specifying that a respective usage of the on-chip memory during the processing of each neural network layer does not exceed a capacity of the on-chip memory.
